(19) United States
(12) Patent Application Publication
(10) Pub. No.: US 2024/0362936 A1
(43) Pub. Date: Oct. 31, 2024

(54) ANOMALY LABELED-ASSISTANT DETECTION SYSTEM AND METHOD THEREOF

(71) Applicant: ASUSTeK COMPUTER INC., Taipei (TW)

(72) Inventors: Hong-Ru SHEN, Taipei (TW); Shu-Chiao LIAO, Taipei (TW); Yu-Ju CHIEN, Taipei (TW); Hung-Ju LIN, Taipei (TW); Shin-Ning GUO, Taipei (TW)

(21) Appl. No.: 18/586,908

(22) Filed: Feb. 26, 2024

(30) Foreign Application Priority Data
Apr. 28, 2023 (TW) 112116147

(51) Int. Cl. G06V 20/70; G06T 7/11; G06V 10/25; G06V 10/40; G06V 10/774

(52) U.S. Cl. CPC G06V 20/70; G06T 7/11; G06V 10/25; G06V 10/40; G06V 10/774; G06T 2207/20132

(57) ABSTRACT

An anomaly labeled-assistant detection system and a method thereof are provided. The anomaly labeled-assistant detection system includes a computing apparatus and a storage apparatus. The computing apparatus includes an anomaly labeled detection model, where the computing apparatus detects a plurality of pieces of labeled image data with a labeled category through the anomaly labeled detection model, the anomaly labeled detection model respectively generates an inference category corresponding to each piece of labeled image data, and the computing apparatus compares the labeled category and the inference category according to each piece of labeled image data, and automatically lists the labeled image data as anomaly labeled data when the labeled category of the labeled image data is different from the inference category. The storage apparatus is electrically connected to the computing apparatus, to store the labeled image data.

### CROSS-REFERENCE TO RELATED APPLICATION

This application claims the priority benefit of Taiwan Application Serial No. 112116147, filed on Apr. 28, 2023. The entirety of the above-mentioned patent application is hereby incorporated by reference herein and made a part of specification.

### BACKGROUND OF THE INVENTION

### Field of the Invention

The disclosure relates to an anomaly labeled-assistant detection system and a method thereof that assists in judging correctness of an artificial intelligence model (AI model) in labeling data.

### Description of the Related Art

Before an artificial intelligence (AI) model is deployed, a plurality of tedious procedures need to be executed, including data cleaning, data labeling, model training and verification, and the like. Finally, a model with a stable identification effect is deployed on a production line and other application ends. Although many companies have developed AI application products that are controlled through an interface to save a process of writing code, a labeling process still requires eyes to find a region that needs to be labeled on an image, which not only consumes a lot of energy and efforts, but also easily causes labeling errors. However, in a data set, when image features are too similar and make it difficult to distinguish between similar categories, the labeling errors are also prone to occur, resulting in a poor training effect.

A mechanism for introducing artificial intelligence as an anomaly-assistant label usually uses some labeled images to pre-train the model, and uses an inference result of the model to assist a user in finding an unreasonable labeling result. When the inference result is inconsistent with the labeling result, it is necessary to judge with the eyes whether it is anomaly labeled data or a model identification effect is poor. If it is the anomaly labeled data, the labeling result is corrected; and if the model identification effect is poor, incorrectly identified data needs to be added to the model to retain the model. As a result, repeated retraining consumes a lot of time costs.

### BRIEF SUMMARY OF THE INVENTION

The disclosure provides an anomaly labeled-assistant detection system, including a computing apparatus and a storage apparatus. The computing apparatus includes an anomaly labeled detection model, where the computing apparatus detects a plurality of pieces of labeled image data with a labeled category through the anomaly labeled detection model, the anomaly labeled detection model respectively generates an inference category corresponding to each piece of labeled image data, and the computing apparatus compares the labeled category and the inference category according to each piece of labeled image data, and automatically lists the labeled image data as anomaly labeled data when the labeled category of the labeled image data is different from the inference category. The storage apparatus is electrically connected to the computing apparatus, and the storage apparatus stores the plurality of pieces of labeled image data.

The disclosure further provides an anomaly labeled-assistant detection method, including the following steps: detecting at least one piece of labeled image data with a labeled category through an anomaly labeled detection model, and generating, by the anomaly labeled detection model, an inference category corresponding to the labeled image data; and comparing the labeled category and the inference category according to the labeled image data, and automatically listing the labeled image data as anomaly labeled data when the labeled category of the labeled image data is different from the inference category.

In conclusion, the anomaly labeled-assistant detection system and the method thereof in the disclosure check each piece of labeled image data through the anomaly labeled detection model, to automatically determine whether the labeled image data is anomaly labeled data and remind a user, thereby solving a problem of a poor effect of conventional identification.

### BRIEF DESCRIPTION OF THE DRAWINGS

FIG. 1 is a schematic block diagram of an anomaly labeled-assistant detection system according to an embodiment of the disclosure;

FIG. 2 is a schematic flowchart of an anomaly labeled-assistant detection method according to an embodiment of the disclosure;

FIG. 3 is a schematic flowchart of an anomaly labeled-assistant detection system during preparing data according to an embodiment of the disclosure;

FIG. 4 is a schematic flowchart of an anomaly labeled-assistant detection system during preparing data according to different image categories according to an embodiment of the disclosure;

FIG. 5 is a schematic flowchart of establishing an anomaly labeled detection model adapted to perform single-category detection according to an embodiment of the disclosure;

FIG. 6 is a schematic block diagram of an anomaly labeled-assistant detection system according to another embodiment of the disclosure;

FIG. 7 is a schematic flowchart of establishing an anomaly labeled detection model applicable to a multi-category detection (including a coarse-grained model and a fine-grained model) according to an embodiment of the disclosure;

FIG. 8 is a schematic flowchart of performing an anomaly detection through a coarse-grained model and a fine-grained model according to an embodiment of the disclosure; and

FIG. 9 is a schematic flowchart of performing an anomaly feature detection through an anomaly labeled-assistant detection system and then optimizing an anomaly labeled detection model according to an embodiment of the disclosure.

### DETAILED DESCRIPTION OF THE EMBODIMENTS

Embodiments of the disclosure are described with reference to relevant drawings. In these drawings, the same label represents the same or similar element or circuit. It is to be understood that although the terms such as “first”, “second” are used to describe various elements, components, regions or functions in this specification, these elements, components, regions and/or functions are not restricted by these terms. These terms are only used to separate one element, component, region or function from another element, component, region or function.

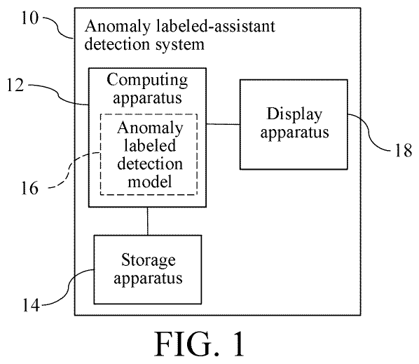

Referring to FIG. 1, an anomaly labeled-assistant detection system 10 includes a computing apparatus 12 and a storage apparatus 14. The computing apparatus 12 includes at least one artificial intelligence (AI) model such as an anomaly labeled detection model 16 inside. The storage apparatus 14 is electrically connected to the computing apparatus 12, the storage apparatus 14 stores a plurality of pieces of labeled image data, and each piece of labeled image data respectively has a labeled category. In the anomaly labeled-assistant detection system 10, the computing apparatus 12 detects the labeled image data with a labeled category through the anomaly labeled detection model 16, and the anomaly labeled detection model 16 respectively generates an inference category corresponding to each piece of labeled image data. The computing apparatus 12 compares the labeled category and the inference category according to each piece of labeled image data, automatically lists the labeled image data as anomaly labeled data when the labeled category of the labeled image data is different from the inference category, and notifies a user that the anomaly labeled data appears.

In an embodiment, referring to FIG. 1, the anomaly labeled-assistant detection system 10 further includes a display apparatus 18. The display apparatus 18 is electrically connected to the computing apparatus 12. The computing apparatus 12 further provides a user interface (not shown in the figure) displayed on the display apparatus 18, to perform the entire process of anomaly labeled detection through the user interface, and the computing apparatus 12 further presents the anomaly labeled data directly on the user interface to notify the user.

In an embodiment, the computing apparatus 12 is, but is not limited to, a central processing unit (CPU), an embedded controller (EC), a microprocessor, a digital signal processor (DSP), an application-specific integrated circuit (ASIC), a system on a chip (SOC), or other similar components or a combination thereof. The disclosure is not limited thereto.

In an embodiment, the storage apparatus 14 is a repetitive read-write and non-temporary memory, such as a flash memory, a solid-state hard drive, or a micro-hard drive, but the disclosure is not limited thereto.

In an embodiment, the computing apparatus 12 obtains the labeled image data with the labeled category through artificial intelligence (AI) software. The AI software is training data generation software for the artificial intelligence model, and is responsible for labeling and recoding the image, and providing a model for training.

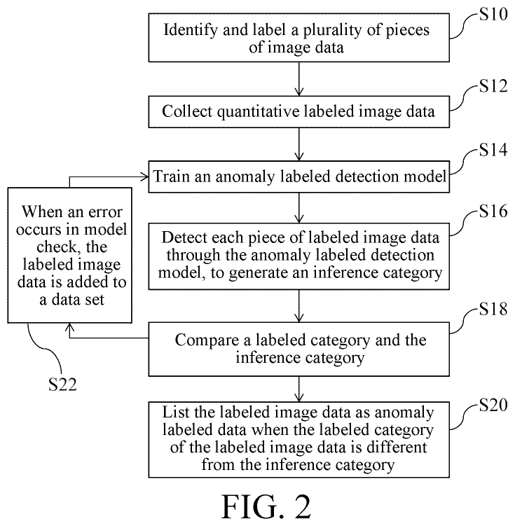

Referring to FIG. 1 and FIG. 2, a detailed process of the anomaly labeled-assistant detection system 10 executing the anomaly labeled-assistant detection method is mainly divided into four parts, including a data preparation process (step S10 and step S12), a model establishment process (steps S14), an auxiliary label check process (step S16, step S18, and step S20), and a model optimization process (step S22).

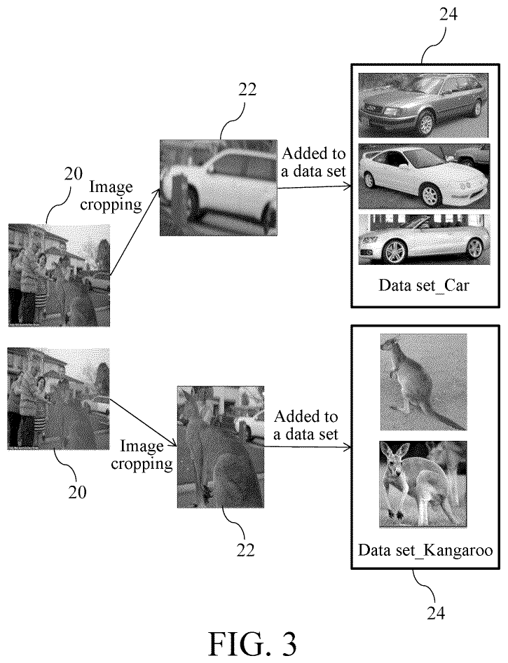

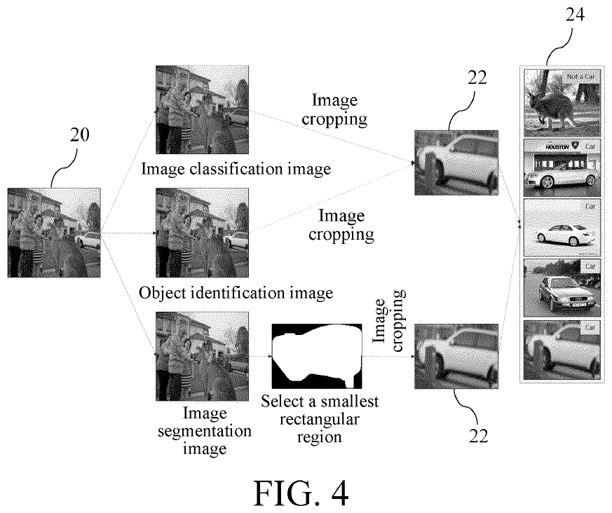

As shown in FIG. 1 and FIG. 2, first, as shown in step S10, the computing apparatus 12 identifies and labels a plurality of pieces of image data through the artificial intelligence software. As shown in FIG. 3, the artificial intelligence software labels a to-be-identified region of each piece of image data 20. After each image category has labeled data, the computing apparatus 12 crops the to-be-identified region according to an image category of the image data 20 to generate labeled image data 22, and then respectively creates a data set 24 corresponding to each piece of labeled image data 22 according to the labeled category for subsequent model establishment. In an embodiment, the artificial intelligence software selects a corresponding cropping method according to different image categories. The image category is an object identification image, an image segmentation image, or an image classification image. As shown in FIG. 4, when the artificial intelligence software selects an image classification model, the image category of the image data 20 is an image classification image. The computing apparatus 12 labels an identification region of the image classification image through the artificial intelligence software, and then crops the identification region to generate the labeled image data 22 and add the labeled image data 22 to the data set 24. When the artificial intelligence software selects an image identification model, the image category of the image data 20 is an object identification image. The computing apparatus 12 labels an object region of the object identification image through the artificial intelligence software, and then crops the object region to generate the labeled image data 22 and add the labeled image data 22 to the data set 24. When the artificial intelligence software selects an image segmentation model, the image category of the image data 20 is an image segmentation image. The computing apparatus 12 labels an object region of the image segmentation image through the artificial intelligence software, selects a smallest rectangular region for the object region, and then crops the rectangular region to generate the labeled image data 22, and add the labeled image data 22 to the data set 24.

As shown in step S12, the computing apparatus 12 automatically collects quantitative labeled image data in the artificial intelligence software, including the foregoing image data that is automatically cropped, to provide sufficient labeled image data to train the anomaly labeled detection model 16.

As shown in FIG. 1 and FIG. 2, following step S14, the computing apparatus 12 trains the anomaly labeled detection model 16 according to the labeled image data to establish the anomaly labeled detection model 16. In an embodiment, the anomaly labeled detection model 16 has two implementations. A first category of the anomaly labeled detection model 16 is adapted to perform single-category anomaly labeled detection, and a second category of the anomaly labeled detection model 16 is adapted to perform multi-category anomaly labeled detection.

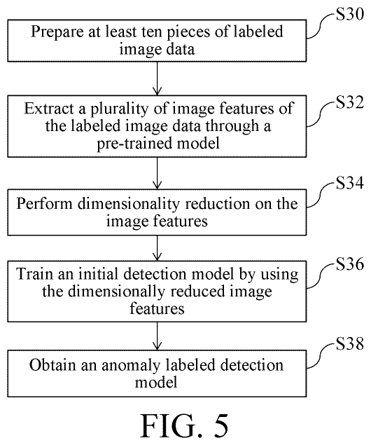

In a process of the computing apparatus 12 establishing the anomaly labeled detection model 16 adapted to perform single-category detection, referring to FIG. 1 and FIG. 5, first, as shown in step S30, in order to establish the anomaly labeled detection model 16, at least ten pieces of labeled image data in the data set corresponding to this single category need to be prepared. As shown in S32, feature extraction is performed on the labeled image data through a pre-trained model to extract a plurality image features. As shown in step S34, the computing apparatus 12 performs dimensionality reduction on the image features to retain the more important image features and reduce training time. In an embodiment, the computing apparatus 12 performs dimensionality reduction on the image features by using a hierarchical clustering method. As shown in step S36, the dimensionally reduced image features are inputted into an initial detection model, and the initial detection model is trained. Finally, as shown in step S38, the trained anomaly labeled detection model 16 is obtained to provide subsequent use of the trained anomaly labeled detection model 16 for anomaly labeled data detection.

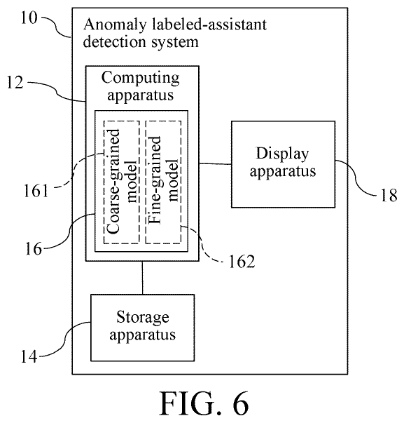

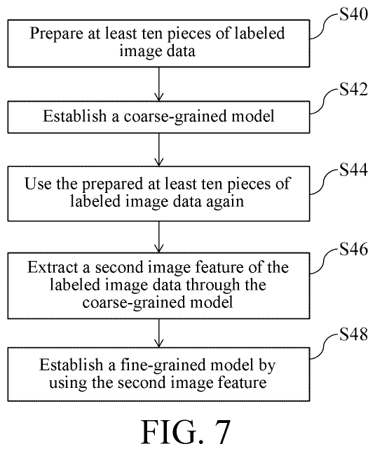

In the anomaly labeled detection model 16 adapted to perform multi-category detection, as shown in FIG. 6, the anomaly labeled detection model 16 further includes a coarse-grained model 161 and a fine-grained model 162. In a process of the computing apparatus 12 establishing the coarse-grained model 161 and the fine-grained model 162 that are adapted to perform multi-category detection, referring to FIG. 6 and FIG. 7, first, as shown in step S40, at least ten pieces of labeled image data in the data set corresponding to each category need to be prepared. As shown in step S42, training is performed according to the labeled image data of each category to establish the coarse-grained model 161. As shown in step S44 and step S46, the prepared at least ten pieces of labeled image data are used again, and feature extraction is performed on the same at least ten pieces of labeled image data by using the coarse-grained model 161 to extract a plurality of second image features. Finally, as shown in step S48, the fine-grained model 162 is established by using the second image features for the subsequent multi-category anomaly labeled detection through the coarse-grained model 161 and the fine-grained model 162.

As shown in FIG. 1 and FIG. 2, after the anomaly labeled detection model 16 is established, the anomaly labeled detection model 16 is started to perform the auxiliary label checking process. As shown in step S16, step S18, and step S20, the computing apparatus 12 detects each piece of labeled image data with a labeled category through the anomaly labeled detection model 16, and the anomaly labeled detection model 16 respectively generates an inference category corresponding to each piece of labeled image data. Then the computing apparatus 12 compares the labeled category and the inference category according to each piece of labeled image data, and finally automatically lists the labeled image data as anomaly labeled data when the labeled category of the labeled image data is different from the inference category, enabling the artificial intelligence software to automatically list the anomaly labeled data inside to notify the user.

In an embodiment, as shown in FIG. 1 and FIG. 2, when the anomaly labeled detection model 16 for the single-category detection is used, the anomaly labeled-assistant detection system 10 performs anomaly labeled detection on the labeled image data and provides a category ranking after checking is performed. The category that ranks first is listed as the inference category of the labeled image data, and when the labeled category and the inference category are different, the labeled image data is listed as anomaly labeled data.

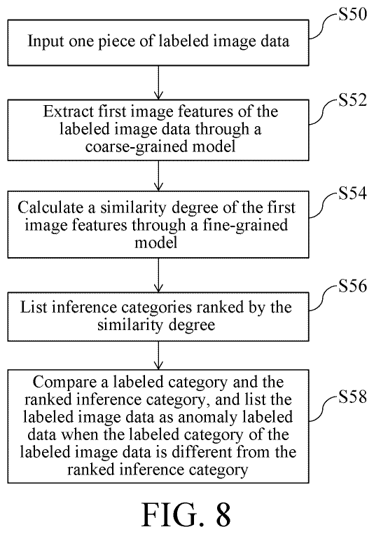

In another embodiment, as shown in FIG. 2 and FIG. 6, when the anomaly labeled detection model 16 for the multi-category detection is used, since the anomaly labeled detection model 16 further includes a coarse-grained model 161 and a fine-grained model 162, the coarse-grained model 161 and the fine-grained model 162 are selected to perform multi-category anomaly labeled detection. Referring to FIG. 6 and FIG. 8, as shown in step S50, a piece of labeled image data is inputted. As shown in step S52, the computing apparatus 12 performs feature extraction on the labeled image data through the coarse-grained model 161 to extract a plurality of first image features. As shown in step S54, a similarity degree of the extracted first image features is calculated through the fine-grained model 162. As shown in step S56, several inference categories ranked by the similarity degree are listed. In an embodiment, the several inference categories ranked by the similarity degree are at most the top five. As shown in step S58, the computing apparatus 12 compares the labeled category of the labeled image data and the ranked inference categories, and lists the labeled image data as anomaly labeled data when the labeled category of the labeled image data is different from the ranked inference categories. In other words, when the labeled category does not appear in the several ranked inference categories, the labeled image data is listed as the anomaly labeled data.

As shown in FIG. 1 and FIG. 2, after the step of comparing the labeled category and the inference category, as shown in step S22, when misjudgment occurs in model check, in an embodiment, when the labeled category and the inference category generated by the anomaly labeled detection model 16 are both incorrect, or when the labeled category is correct but the inference category generated by the anomaly labeled detection model 16 is incorrect, it indicates that an inference effect of the anomaly labeled detection model 16 is poor. In this case, labeled image data corresponding to the incorrect inference category is added to the data set, so as to return to step S14 again to retrain the anomaly labeled detection model 16, thereby optimizing the anomaly labeled detection model 16. In an embodiment, when the user checks a labeling result and finds that there is a gap with an expected identification effect of the anomaly labeled detection model 16, a to-be-optimized label is created for labeled image data with a poor identification effect, and the computing apparatus 12 adds all labeled image data listed as the to-be-optimized label to the corresponding data set, so as to return to step S14 to train and adjust the anomaly labeled detection model 16 again.

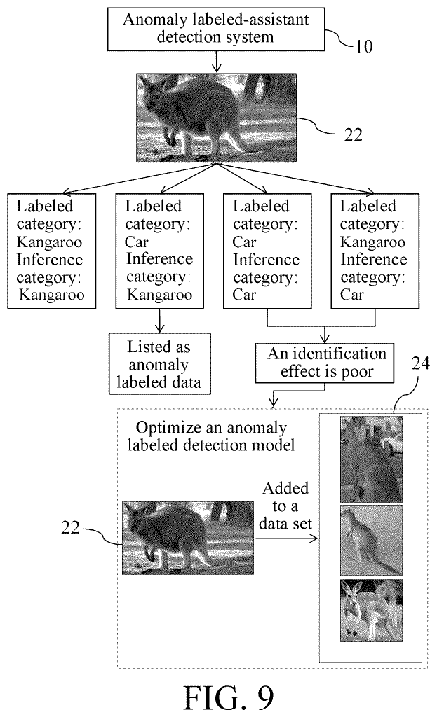

Using an example in which an actual cropped Kangaroo image is used as the labeled image data. Refer to FIG. 1 and FIG. 9 together. When the anomaly labeled-assistant detection system 10 performs data review, the labeled image data 22 with a labeled category is detected through the anomaly labeled detection model 16, so that the anomaly labeled detection model 16 generates an inference category corresponding to the labeled image data 22. When the labeled category is Kangaroo and the inference category is Kangaroo, it indicates that the artificial intelligence software labels correctness and the anomaly labeled detection model 16 also labels correctness when performing review. When the labeled category is Car and the inference category is Kangaroo, it indicates that the labeled category of the labeled image data 22 is different from the inference category, and therefore the labeled image data 22 is listed as anomaly labeled data. When the labeled category is Car and the inference category is Car, or when the labeled category is Kangaroo and the inference category is Car, it indicates that a model identification effect is poor. In this case, the labeled image data 22 is added to the data set 24, and the anomaly labeled detection model 16 is retrained and adjusted to optimize the anomaly labeled detection model 16.

In conclusion, the anomaly labeled-assistant detection system and the method thereof in the disclosure check each piece of labeled image data through the anomaly labeled detection model, to automatically determine whether the labeled image data is anomaly labeled data and remind a user, thereby solving a problem of a poor effect of conventional identification. Therefore, compared with the prior art, the disclosure has the following characteristics. Since the disclosure needs to cut an image through pre-processing, the disclosure combines artificial intelligence software to save processing time for data cutoff; when the artificial intelligence software performs a labeling process, review is performed through an anomaly labeled-assistant detection system or an anomaly labeled-assistant detection method to add a protective measure to avoid labeling errors, and anomaly labeled data is automatically listed in the artificial intelligence software; and the anomaly labeled detection model established through labeled image data re-adds the labeled image data to a data set to optimize the model when a training effect is misjudged, without spending a lot of time on repeated training.

The embodiments described above are only used for explaining the technical ideas and characteristics of the disclosure to enable a person skilled in the art to understand and implement the content of the disclosure, and are not intended to limit the patent scope of the disclosure. That is, any equivalent change or modification made according to the spirit disclosed in the disclosure shall still fall within the patent scope of the disclosure.

What is claimed is:

1. An anomaly labeled-assistant detection system, comprising:
a computing apparatus, comprising an anomaly labeled detection model, wherein the computing apparatus detects a plurality of pieces of labeled image data with a labeled category through the anomaly labeled detection model, the anomaly labeled detection model respectively generates an inference category corresponding to each piece of labeled image data, and the computing apparatus compares the labeled category and the inference category according to each piece of labeled image data, and automatically lists the labeled image data as anomaly labeled data when the labeled category of the labeled image data is different from the inference category; and
a storage apparatus, electrically connected to the computing apparatus, wherein the storage apparatus stores the plurality of pieces of labeled image data.

2. The anomaly labeled-assistant detection system according to claim 1, wherein the computing apparatus obtains the plurality of pieces of labeled image data with the labeled category through artificial intelligence software.

3. The anomaly labeled-assistant detection system according to claim 2, wherein the computing apparatus identifies and labels a plurality of pieces of image data through the artificial intelligence software to label a to-be-identified region of each piece of image data, and crops the to-be-identified region according to an image category of each piece of image data to generate the plurality of pieces of labeled image data, and then respectively creates a data set corresponding to each piece of labeled image data according to the labeled category.

4. The anomaly labeled-assistant detection system according to claim 3, wherein the image category is an object identification image, an image segmentation image, or an image classification image.

5. The anomaly labeled-assistant detection system according to claim 3, wherein before the computing apparatus performs single-category anomaly labeled detection through the anomaly labeled detection model, the anomaly labeled detection model is first established, and the method comprises: preparing at least ten pieces of the labeled image data in the data set corresponding to the single category; performing feature extraction on the labeled image data by using a pre-trained model, to extract a plurality of image features; and performing dimensionality reduction on the image features and inputting the image features into an initial detection model for training to obtain a trained anomaly labeled detection model.

6. The anomaly labeled-assistant detection system according to claim 5, wherein the computing apparatus performs dimensionality reduction on the image features by using a hierarchical clustering method.

7. The anomaly labeled-assistant detection system according to claim 5, wherein when the labeled category and the inference category generated by the anomaly labeled detection model are both incorrect, or when the labeled category is correct but the inference category generated by the anomaly labeled detection model is incorrect, labeled image data corresponding to the incorrect inference category is added to the data set to retrain the anomaly labeled detection model.

8. The anomaly labeled-assistant detection system according to claim 2, wherein when the computing apparatus performs multi-category anomaly labeled detection by using the anomaly labeled detection model, the anomaly labeled detection model further comprises a coarse-grained model and a fine-grained model, the computing apparatus extracts a plurality of first image features of the labeled image data through the coarse-grained model, then calculates a similarity degree of the first image features through the fine-grained model, and lists several inference categories ranked by the similarity degree, the computing apparatus compares the labeled category of the labeled image data and the several ranked inference categories, and when the labeled category of the labeled image data is different from the several ranked inference categories, the labeled image data is listed as the anomaly labeled data.

9. The anomaly labeled-assistant detection system according to claim 8, wherein the several inference categories ranked by the similarity degree are at most the top five.

10. The anomaly labeled-assistant detection system according to claim 8, wherein the computing apparatus identifies and labels a plurality of pieces of image data through the artificial intelligence software to label a to-be-identified region of each piece of image data, and crops the to-be-identified region according to an image category of each piece of image data to generate the plurality of pieces of labeled image data, and then respectively creates a data set corresponding to each piece of labeled image data according to the labeled category.

11. The anomaly labeled-assistant detection system according to claim 10, wherein the image category is an object identification image, an image segmentation image, or an image classification image.

12. The anomaly labeled-assistant detection system according to claim 10, wherein before the computing apparatus performs the multi-category anomaly labeled detection through the anomaly labeled detection model, the coarse-grained model and the fine-grained model are first established, and the method comprises: preparing at least ten pieces of the labeled image data in the data set corresponding to each category for training, to establish the coarse-grained model; and extracting a plurality of second image features of the same at least ten pieces of the labeled image data through the coarse-grained model, and establishing the fine-grained model by using the second image features, to perform the multi-category anomaly labeled detection through the coarse-grained model and the fine-grained model.

13. The anomaly labeled-assistant detection system according to claim 12, wherein when the labeled category and the inference category generated by the anomaly labeled detection model are both incorrect, or when the labeled category is correct but the inference category generated by the anomaly labeled detection model is incorrect, labeled image data corresponding to the incorrect inference category is added to the data set to retrain the coarse-grained model and the fine-grained model.

14. The anomaly labeled-assistant detection system according to claim 1, further comprising a display apparatus electrically connected to the computing apparatus, wherein the computing apparatus further provides a user interface displayed on the display apparatus, to perform anomaly labeled detection through the user interface.

15. An anomaly labeled-assistant detection method, comprising:
detecting at least one piece of labeled image data with a labeled category through an anomaly labeled detection model, and generating, by the anomaly labeled detection model, an inference category corresponding to the labeled image data; and
comparing the labeled category and the inference category according to the labeled image data, and automatically listing the labeled image data as anomaly labeled data when the labeled category of the labeled image data is different from the inference category.

16. The anomaly labeled-assistant detection method according to claim 15, wherein before the step of detecting the labeled image data, the method further comprises: identifying and labeling a plurality of pieces of image data through artificial intelligence software to label a to-be-identified region of each piece of image data; cropping the to-be-identified region according to an image category of the image data to generate the labeled image data; and respectively creating a data set corresponding to the labeled image data according to the labeled category.

17. The anomaly labeled-assistant detection method according to claim 16, wherein the image category is an object identification image, an image segmentation image, or an image classification image.

18. The anomaly labeled-assistant detection method according to claim 16, wherein before the step of performing single-category anomaly labeled detection through the anomaly labeled detection model, the anomaly labeled detection model is first established, and the method comprises: preparing at least ten pieces of the labeled image data in the data set corresponding to the single category; performing feature extraction on the labeled image data by using a pre-trained model, to extract a plurality of image features; and performing dimensionality reduction on the image features and inputting the image features into an initial detection model for training to obtain a trained anomaly labeled detection model.

19. The anomaly labeled-assistant detection method according to claim 18, wherein in the step of performing dimensionality reduction on the image features, dimensionality reduction is performed on the image features by using a hierarchical clustering method.

20. The anomaly labeled-assistant detection method according to claim 18, wherein when the labeled category and the inference category generated by the anomaly labeled detection model are both incorrect, or when the labeled category is correct but the inference category generated by the anomaly labeled detection model is incorrect, labeled image data corresponding to the incorrect inference category is added to the data set to retrain the anomaly labeled detection model.

21. The anomaly labeled-assistant detection method according to claim 15, wherein when multi-category anomaly labeled detection is performed through the anomaly labeled detection model, the anomaly labeled detection model further comprises a coarse-grained model and a fine-grained model, to extract a plurality of first image features of the labeled image data through the coarse-grained model, calculate a similarity degree of the first image features through the fine-grained model, list several inference categories ranked by the similarity degree, compare the labeled category of the labeled image data and the several ranked inference categories, and list the labeled image data as the anomaly labeled data when the labeled category of the labeled image data is different from the several ranked inference categories.

22. The anomaly labeled-assistant detection method according to claim 21, wherein the several inference categories ranked by the similarity degree are at most the top five.

23. The anomaly labeled-assistant detection method according to claim 21, wherein before the step of detecting the labeled image data, the method further comprises: identifying and labeling a plurality of pieces of image data through artificial intelligence software to label a to-be-identified region of each piece of image data; cropping the to-be-identified region according to an image category of the image data to generate the labeled image data; and respectively creating a data set corresponding to the labeled image data according to the labeled category.

24. The anomaly labeled-assistant detection method according to claim 23, wherein the image category is an object identification image, an image segmentation image, or an image classification image.

25. The anomaly labeled-assistant detection method according to claim 23, wherein before multi-category anomaly labeled detection is performed through the anomaly labeled detection model, the coarse-grained model and the fine-grained model are first established, and the method comprises: preparing at least ten pieces of the labeled image data in the data set corresponding to each category for training, to establish the coarse-grained model; and extracting a plurality of second image features of the same at least ten pieces of the labeled image data through the coarse-grained model; and establishing the fine-grained model by using the second image features, to perform the multi-category anomaly labeled detection through the coarse-grained model and the fine-grained model.

26. The anomaly labeled-assistant detection method according to claim 25, wherein when the labeled category and the inference category generated by the anomaly labeled detection model are both incorrect, or when the labeled category is correct but the inference category generated by the anomaly labeled detection model is incorrect, labeled image data corresponding to the incorrect inference category is added to the data set to retrain the coarse-grained model and the fine-grained model.
